(19) United States
(12) Patent Application Publication
(10) Pub. No.: US 2007/0237114 A1
(43) Pub. Date: Oct. 11, 2007

(54) Wireless data session handoff using location update message

(75) Inventors: Neeraj C. Mehta, Wheeling, IL (US); Shreesha Ramanna, Vernon Hills, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/393,644

(22) Filed: Mar. 30, 2006

(51) Int. Cl. H04Q 7/00

(52) U.S. Cl. 370/331; 455/436

(57) ABSTRACT

A High Rate Packet Data (HRPD) wireless access network station (400) that accepting a data session handoff from a CDMA2000 1x base station. The wireless access network station (400) receives, from an access terminal (120), a location notification message with a valid Previous Access Network Identifier (PANID). The wireless access network station (400) further receives session parameters from a remote access network having a previous data session with the access terminal and determines if the PANID is consistent with the session parameters received from the remote access network. The wireless access network station (400) further has a data session controller (402,416) that, in response to determining the PANID is not consistent with the session parameters, establishes an RF traffic channel and connects a data session between the access terminal (120) and a Packet Data Serving Node (208) based upon the PANID received from the access terminal.

### CROSS-REFERENCE TO RELATED APPLICATION

Not Applicable

### FIELD OF THE INVENTION

The present invention generally relates to the field of wireless data communications protocols, and more particularly relates to performing handoffs of wireless data sessions between CDMA2000 1x and High Rate Packet Data (HRPD) protocols.

### BACKGROUND OF THE INVENTION

The High Rate Packet Data (HRPD) protocol defines operations that support handing off of an Access Terminal (AT) from one HRPD Access Network (AN) to another while a data session with the AT exists. Maintaining an existing data session through a handoff process allows an AT to be reachable through the data session after the handoff to another AN.

The current protocol supports a handoff of an AT between an HRPD AN and a base station that uses the CDMA2000 1x protocol. In several scenarios involving an existing but dormant data session, a data session established between an AT and an HRPD AN is not properly re-established with another HRPD AN if the AT has continued the data session through a CDMA2000 1x base station in the interim. The inability to properly maintain this data connection results in an inability of remote devices to reach the AT through the HRPD network after this handoff scenario.

Therefore a need exists to overcome the problems with the prior art as discussed above.

### SUMMARY OF THE INVENTION

Briefly, in accordance with the present invention, disclosed are a method, device, and system for cooperative diversity wireless communication. The method of accepting a handoff between a CDMA2000 1x data session and a High Rate Packet Data data session includes receiving session parameters from a remote access network having a previous data session with an access terminal. The method further includes receiving, from the access terminal, a location notification message comprising a valid Previous Access Network Identifier. The method also includes determining that the Previous Access Network Identifier is not consistent with data contained within the session parameters received from the remote access network. The method further includes connecting, in response to the determining that the Previous Access Network Identifier is not consistent with the data contained within the session parameters, a data session between the access terminal and a Packet Data Serving Node based upon the Previous Access Network Identifier received from the access terminal.

In yet another embodiment of the present invention, a wireless access network station includes an access terminal interface controller that receives, from a remote access terminal, a location notification message. The location notification message includes a valid Previous Access Network Identifier. The wireless access network station further includes a data session controller that is communicatively coupled to the access terminal interface controller and that receives session parameters from a remote access network having a previous data session with an access terminal. The data session controller also determines that the Previous Access Network Identifier is not consistent with data contained within the session parameters received from the remote access network and connects, in response to the determining that the Previous Access Network Identifier is not consistent with the data contained within the session parameters, a data session between the access terminal and a Packet Data Serving Node based upon the Previous Access Network Identifier received from the access terminal.

An advantage of the present invention is that an access terminal (AT) is able to perform a series of handoffs between HRPD Access Networks (ANs) and CDMA2000 1x base stations while maintaining a dormant data session. Embodiments of the present invention utilize the HRPD location update message during the handoff process of AT to obtain a correct PANID for the dormant data session and correctly reestablish the data session through the target AN of the handoff.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a system diagram for a wireless communication system, according to an embodiment of the present invention;

FIG. 2 is a data session call handoff message flow diagram illustrating according to an embodiment of the present invention;

FIG. 3 is a data session call handoff processing flow diagram, according to an embodiment of the present invention; and

FIG. 4 is a system block diagram of an access network station, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as illustrative examples for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The present invention, according to an embodiment, overcomes problems with the prior art by effectively accepting communications with an Access Terminal (AT) during a handoff process and maintaining a currently existing data communications session that had been set up through other access network stations. Exemplary embodiments of the present invention perform processing when accepting an AT during handoff processing that obtains session parameters from the HRPD RAN for an existing data communications session in which the AT is in a dormant state, compares those parameters to the session parameters obtained from the AT during conventional inter HRPD dormant handoff processing and, if there is a difference in those two parameters, performs processing to reconnect the AT to the data session specified in the session parameters provided by the AT.

The term Access Terminal (AT) as used herein is intended to broadly cover many different types of devices that can wirelessly receive signals, and optionally can wirelessly transmit signals, and may also operate in a wireless communication system. For example, and not for any limitation, a wireless device can include any one or a combination of the following: a cellular telephone, a mobile phone, a smartphone, a two-way radio, a two-way pager, a wireless messaging device, a multi-mode wireless device capable of communicating using more than one voice service such as push-to-talk (PTT) (e.g., dispatch and/or PoC (PTT over cellular)) and interconnect (e.g., cellular), or the like.

This description of the exemplary embodiments of the present invention refers to protocols and operations described and defined within the “Interoperability Specification (IOS) for High Rate Packet Data (HRPD) Radio Access Network Interfaces with Session Control in the Packet Control Function,” Document 3GPP2 A.S0009-A v1.0, Date: March 2006, produced by the 3^{rd} Generation Partnership Project 2 “3GPP2,” the entire contents and teachings of Document 3GPP2 A.S0009-A v1.0 are explicitly incorporated herein by reference.

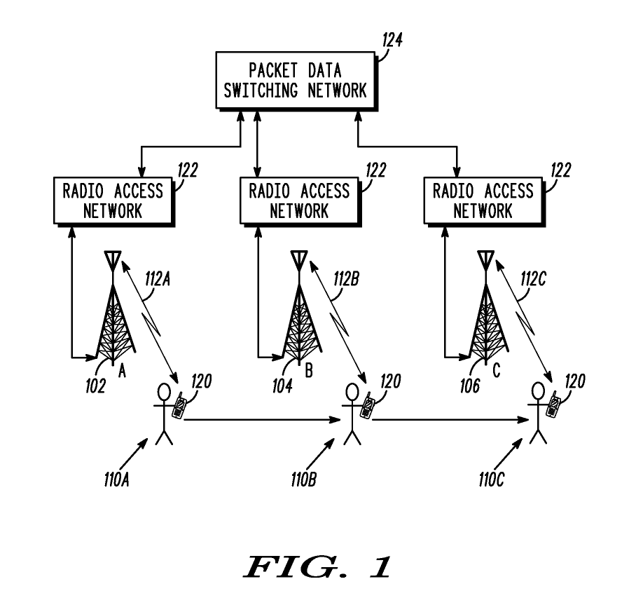

FIG. 1 is a system diagram for a wireless communication system 100, according to an embodiment of the present invention. The wireless communications system 100 shows three access network towers: an access network tower A 102, an access network tower B 104 and an access network tower C 106. An access terminal held by a user is shown in three locations: access terminal in location “a” 110a, access terminal in location “b” 110b, and access terminal in location “c” 110c. These three access terminal locations are intended to illustrate a single user successively carrying a single access terminal to three disparate locations. In each of these different locations, the access terminal has a respective wireless link to a different access network tower. Access terminal in location “a” 110a is shown to have a first wireless link 112a to access network tower A 102, access terminal in location “b” 110b is shown to have a second wireless link 112b to access network tower B 104, and access terminal in location “c” 110c is shown to have a third wireless link 112c to access network tower C 106.

The wireless communication system 100 of the exemplary embodiment locates a Radio Access Network (RAN) 122 at each access network tower, including access network tower A 102, access network tower B 104, and access network tower C 106. The RANs 122 perform the control and communications processing to implement data communications between the access terminal 120 and other devices. The RANs 122 of the exemplary embodiment are in communications with a Packet Data Switching Network (PDSN) 124. The PDSN 124 controls data communications sessions between an access terminal 120 and other devices, such as other access terminals, the Internet, or any other data communications device.

In the operation of a wireless communications system such as shown for the exemplary embodiment, communications sessions are maintained in a seamless manner as an access terminal changes the access networks with which it is in communications. For example, a user is able to use an access terminal in location “a” 110a, move the same access terminal to a location that corresponds to the access terminal in location “b” 110b, and then move with the same access terminal to a location that corresponds to the access terminal in location “c” 110c. While moving through these three locations, a data session is desired to be maintained without any disruption being perceived by the user.

The exemplary embodiments of the present invention addresses a deficiency in the High Rate Packet Data Radio Access Network interface specification with regards to handing off an access terminal among HRPD and CDMA2000 1x wireless systems while maintaining connectivity for an established data session when that data session is in a dormant state. The deficiency, and the applicability of embodiments of the present invention, becomes apparent in several scenarios. A few such example scenarios are described below.

One scenario occurs when an AT moves among three stations, e.g., from an HRPD station identified as BSC-DO-1 to a CDMA2000 1x station identified as BSC-1X and then to a second HRPD station identified as BSC-DO-2. In this example, BSC-DO-1 corresponds to access network A 102, BSC-1X corresponds to access network B 104, and BSC-DO-2 corresponds to access network C 106. In this scenario, BSC-DO2 will receive the data session parameters from the session that was established with BSC-DO-1. This results in BSC-DO-2 assuming that the PANID=BSC-DO-1. This assumption is incorrect since the AT is coming from BSC-1X. Since an incorrect data session would be set up in this scenario, there is a possibility that the future pages to the AT will be lost.

Another scenario exists when an AT moves from BSC-DO-1 to a third HRPD station, which can be identified as BSC-DO-9 in this description, and then to BSC-DO-2. In this scenario, the third HRPD station, BSC-DO-9, does not have an A13 interface link with BSC-DO-1 or BSC-DO-2. In this example, BSC-DO-1 corresponds to access network A 102, BSC-DO-9 corresponds to access network B 104, and BSC-DO-2 corresponds to access network C 106. In this scenario, a correct determination of whether the AT had an A10 data session prior to connecting to BSC-DO-2 cannot be made, and the AT cannot be connected to the correct data session.

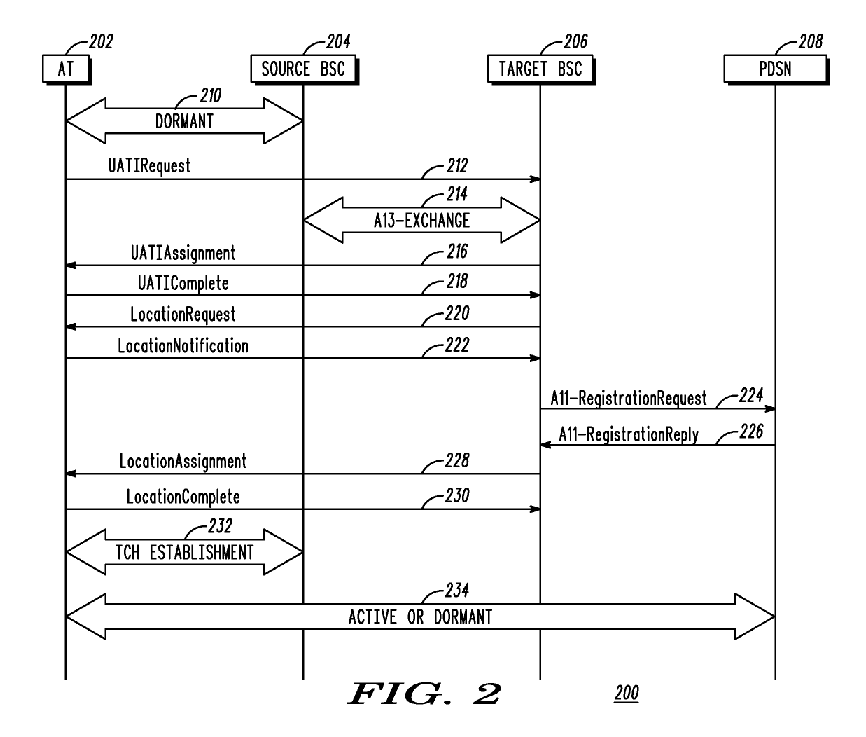

FIG. 2 is a data session call handoff message flow diagram 200 according to an embodiment of the present invention. The data session call handoff message flow diagram 200 illustrates an example exchange of messages between an access terminal 202, a Packet Data Serving Node PDSN 208, an access network that had a previous data session with the access terminal—identified as Source BSC 204, and an access network with which the access terminal is associating—identified as Target BSC 206. As is understood by ordinary practitioners in the relevant arts in light of the present discussion, alternative message exchange scenarios are able to be performed by further embodiments of the present invention.

At the beginning of the data session call handoff message flow 200, the AT 202 is in a dormant state 210 with relation to the Source BSC 204. In order to initiate a handoff of the AT 202 from the Source BSC 204 to the Target BSC 206, the AT transmits a UATIRequest message 212 to the Target BSC 206. In response to receiving the UATIRequest message 212, the Target BSC performs an A13-Exchange 214 with the Source BSC 204 to retrieve session parameters that apply to the AT 202 being handed off and also to further support the handoff. The Source BSC 204 is considered to be a remote access network in the context of this discussion. The A13-Exchange 214 performs data exchanges according to the A13 interface defined for HRPD systems and allows, for example, the target BSC 206 to obtain data session parameters for existing data sessions between the Source BSC 204 and the AT 202.

The Target BSC 206 sends, after performing the A13-Exchange 214, a UATIAssignment message 216 to the AT 202. The AT 202 responds by sending a UATIComplete message 218 to the Target BSC 206. The above message exchange is consistent with conventional HRPD processing.

In response to receiving a UATIComplete message from the AT 202, the processing of the exemplary embodiment transmits a LocationRequest message 220 to the AT 202. In response to receiving the LocationRequest message 220, the AT 202 transmits a LocationNotification message 222 to the Target BSC 206. The LocationNotification message 222 contains the Previous Access Network Identifier (PANID) that is associated with the established data session configured for the AT 202.

The processing of the exemplary embodiment, as is described below, compares the PANID received from the Source BSC 204 and the PANID received from the AT 204. If that comparison determines that these two PANID values are different, the processing uses the PANID received from the AT 204 instead of the PANID received from the Source BSC 204 to configure the data session, as is described below.

In response to receiving the LocationNotification message 222 and the above described comparison, the Target BSC 206 sends an A11-RegistrationRequest message over an A11 interface to the Packet Data Serving Node 208. This A11-RegistrationRequest 224 is a request to reconfigure the existing data session with the AT 202 to operate through the Target BSC 206. In the event that the PANID received from the Source BSC 206 differs from the PANID received from the AT 202, the A11-RegistrationRequest 224 contains the PANID received from the AT 202 through the LocationNotification 222 message, thereby overriding the PANID received from the Source BSC 206. In response to receiving the A11-RegistrationRequest message 224, the PDSN 208 sends an A11-RegistrationReply message 226 to the Target BSC 206.

The Target BSC 206 then sends a LocationAssignment message 228 to the AT 202, and the AT 202 responds by sending a LocationComplete message 230. After sending the LocationComplete message 230, a TCH Establishment 232 is performed to establish a traffic channel with the AT 202 and to allocate RF resources to facilitate the reconfiguration of the data session with the PDSN 208 based on the PANID comparison described above. The AT 202 and the PDSN 208 then maintain a data session 234 in either a dormant or active state until data is to be transferred between the AT 202 and the PDSN 208.

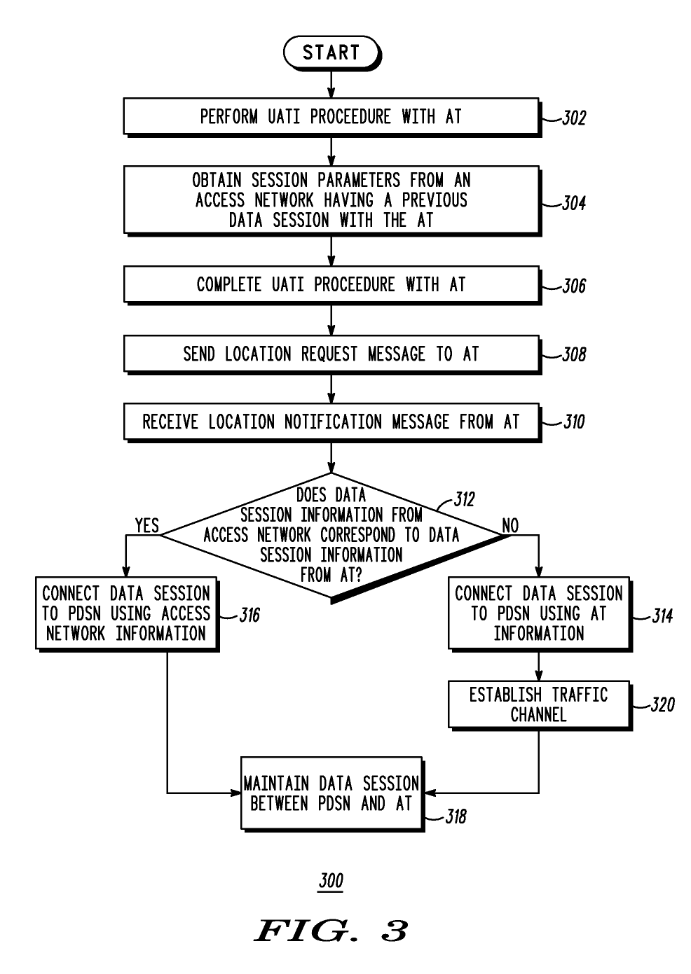

FIG. 3 is a data session call handoff processing flow diagram 300, according to an embodiment of the present invention. The exemplary data session call handoff processing flow diagram 300 is performed by an access network station of the exemplary embodiment. The data session call handoff processing flow diagram 300 begins by performing, at step 302, a UATI procedure with an Access Terminal (AT) 202. The exemplary embodiment performs a conventional UATI procedure as part of this dormant handoff processing. The processing then obtains, at step 304, session parameters from a remote access network that has had a previous data session with the AT 202. These session parameters are obtained in a conventional manner through an A13 interface and include session parameters for any existing data sessions with the AT 202. The processing next completes, at step 306, the UATI procedure with the AT 202.

The data session call handoff processing flow diagram 300 of the exemplary embodiment proceeds by sending, at step 308, a LocationRequest message to the AT 202. The processing next receives, at step 310, a LocationNotification message from the AT 202. As defined for HRPD wireless systems, the LocationNotification message contains a valid PANID for a currently existing data session.

The processing continues by determining, at step 312, if the data session information from the Access Network (AN), as obtained through the A13 interface described in relation to the processing of step 304, corresponds to the session information obtained by the LocationNotification message received from the AT 202. If the data session information from the Access Network (AN) corresponds to the session information obtained by the LocationNotification message received from the AT 202, the processing continues by connecting, at step 316, a data session to the PDSN 208 based upon the information obtained from the AN through the A13 interface. If the data session information from the Access Network (AN) does not correspond to the session information obtained by the LocationNotification message received from the AT 202, the processing continues by connecting, at step 314, a data session to the PDSN 208 based upon the session information obtained from the AT 202. Connecting the data session for the AT 202 to the PDSN 208 is performed by the exemplary embodiment as described above for the data session call handoff message flow 200. As noted above, this connection includes setting up, at step 320, a traffic channel/RF resources to facilitate the data session reconfiguration with the PDSN 208. The processing continues by maintaining, at step 318, a data session between the PDSN 208 and the AT 202.

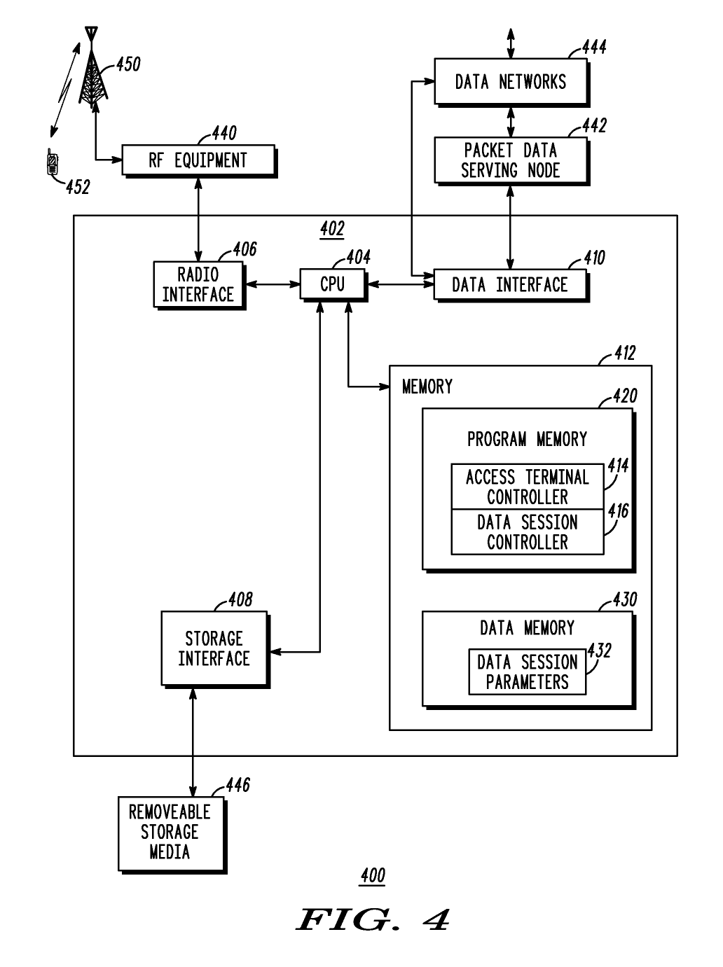

FIG. 4 is a system block diagram of an access network station 400, according to an embodiment of the present invention. The access network station 400 of the exemplary embodiment includes RF equipment 440 that operates with RF tower/antenna 450 to provide bidirectional RF communications between the access network station 400 and access terminals (AT) 452. Access terminal 452 is shown to provide the operational context of the access network but is not a part of the access network itself.

The access network station 400 includes a data processor 402 to perform controlling functions for the access network station 400 as well as implement various control operations of the HRPD system. Data processor 402 includes a Central Processing Unit (CPU) 404, which is a programmable processor that executes programs and manipulates data. The CPU 404 communicates with a radio interface 406 to control, and to provide messages for transmission through, RF equipment 404. The CPU 404 further communicates through data interface 410 to implement data communications to remote data processing elements, including through the packet data serving node (PDSN) 442 and to data networks 444.

In order to improve the clarity of the description of the access network station 400, the interface with the Packet Data Serving Node (PDSN) 442 and the data networks 444 are shown. The PDSN 442 and the data networks 444 are not part of the access network itself. The PDSN 442 is usually located remotely from the access network as is discussed above. The data networks 444 include, for example, the Internet and other public and private data communications networks. The data communications equipment 442, through data networks 444, provides various data communications interfaces to, for example, other access networks and includes the A13 interface described above.

The CPU 404 of the exemplary embodiment communicates with memory 412. Memory 412 includes a program memory 420 and a data memory 430. Program memory 420 includes an access terminal controller program 414 that defines the processing performed by the CPU in managing and/or controlling the operation of the wireless network. The program memory 420 further includes a data session controller program 416 that defines the processing performed by the CPU in managing and/or controlling the operation of data communications sessions between the AT 452 and the Packet Data Serving Node 442 and/or data networks 444. The Data memory 430 includes storage of data session parameters 432 as are stored and communicated to support data sessions between ATs 452 and the PDSN 442.

The CPU 404 of the exemplary embodiment further communicates with a storage interface 408 that allows communicative connection to a removable machine readable medium 446 that contains, for example, one or more machine executable programs.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of accepting a handoff between a CDMA2000 1x data session and a High Rate Packet Data data session, the method comprising:
receiving session parameters from a remote access network having a previous data session with an access terminal;
receiving, from the access terminal, a location notification message comprising a valid Previous Access Network Identifier;
determining that the Previous Access Network Identifier is not consistent with data contained within the session parameters received from the remote access network; and
connecting, in response to the determining that the Previous Access Network Identifier is not consistent with the data contained within the session parameters, a data session between the access terminal and a Packet Data Serving Node based upon the Previous Access Network Identifier received from the access terminal.

2. The method of claim 1, further comprising:
performing a Unicast Access Terminal Identifier procedure with the access terminal; and
sending to the access terminal, in response to the performing, a location request,
wherein the location notification message is transmitted by the access terminal in response to the sending.

3. The method of claim 1, wherein the requesting session parameters from the remote access network comprises a data exchange through an A13 interface.

4. The method of claim 1, wherein the connecting the data session to the Packet Data Serving Node comprises:
sending, through an A11 interface and in response to determining that the Previous Access Network Identifier received from the access terminal is not consistent with data contained within the session parameters, a registration request to the Packet Data Serving Node; and
receiving, through the A11 interface and in response to the sending, a registration reply.

5. The method of claim 1, wherein the connecting the data session to the Packet Data Serving Node comprises establishing a traffic channel with the access terminal.

6. A wireless access network station, comprising:
an access terminal interface controller that receives, from a remote access terminal, a location notification message, the location notification message comprising a valid Previous Access Network Identifier; and
a data session controller, communicatively coupled to the access terminal interface controller, that:
receives session parameters from a remote access network having a previous data session with an access terminal;
determines that the Previous Access Network Identifier is not consistent with data contained within the session parameters received from the remote access network; and
connects, in response to the determining that the Previous Access Network Identifier is not consistent with the data contained within the session parameters, a data session between the access terminal and a Packet Data Serving Node based upon the Previous Access Network Identifier received from the access terminal.

7. The wireless access network of claim 6, wherein the access terminal interface controller further:
performs a Unicast Access Terminal Identifier procedure with the access terminal; and
sends to the access terminal, in response to performing the Unicast Access Terminal Identifier procedure, a location request,
wherein the location notification message is transmitted in response to sending the location request.

8. The wireless access network of claim 6, wherein the data session controller comprises an A13 interface with the remote access network, and wherein the data session controller requests session parameters through a data exchange through the A13 interface.

9. The wireless access network of claim 6, wherein the data session controller comprises an A11 interface and the data session controller connects by:
sending, through an A11 interface and in response to determining that the Previous Access Network Identifier received from the access terminal is not consistent with data contained within the session parameters, a registration request to the Packet Data Serving Node; and
receiving, through the A11 interface and in response to sending the registration request, a registration reply.

10. The wireless access network of claim 6, wherein the access terminal interface controller further connects by establishing a traffic channel with the access terminal.

11. A machine readable medium encoded with a machine executable program for accepting a handoff between a CDMA2000 1x data session and a High Rate Packet Data data session, the machine executable program comprising instructions for:
receiving session parameters from a remote access network having a previous data session with an access terminal;
receiving, from the access terminal, a location notification message comprising a valid Previous Access Network Identifier;
determining that the Previous Access Network Identifier is not consistent with data contained within the session parameters received from the remote access network; and
connecting, in response to the determining that the Previous Access Network Identifier is not consistent with the data contained within the session parameters, a data session between the access terminal and a Packet Data Serving Node based upon the Previous Access Network Identifier received from the access terminal.

12. The machine readable medium of claim 11, further comprising instructions for:
performing a Unicast Access Terminal Identifier procedure with the access terminal; and
sending to the access terminal, in response to the performing, a location request,
wherein the location notification message is transmitted by the access terminal in response to the sending.

13. The machine readable medium of claim 11, wherein the instructions for requesting session parameters from the remote access network comprises instructions for a data exchange through an A13 interface.

14. The machine readable medium of claim 11, wherein the instructions for connecting the data session to the Packet Data Serving Node comprises instructions for:
sending, through an A11 interface and in response to determining that the Previous Access Network Identifier received from the access terminal is not consistent with data contained within the session parameters, a registration request to the Packet Data Serving Node; and
receiving, through the A11 interface and in response to the sending, a registration reply.

15. The machine readable medium of claim 11, wherein the instructions for connecting the data session to the Packet Data Serving Node comprises instructions for establishing a traffic channel with the access terminal.
